(19) United States
(12) Patent Application Publication
(10) Pub. No.: US 2017/0026901 A1
(43) Pub. Date: Jan. 26, 2017

(54) NEIGHBOR AWARE NETWORK DATA LINK PRESENCE INDICATION

(71) Applicant: QUALCOMM Incorporated, San Diego, CA (US)

(72) Inventors: Abhishek Pramod Patil, San Diego, CA (US); Santosh Paul Abraham, San Diego, CA (US); George Cherian, San Diego, CA (US); Alireza Raissinia, San Diego, CA (US)

(21) Appl. No.: 15/214,283

(22) Filed: Jul. 19, 2016

Related U.S. Application Data
(60) Provisional application No. 62/195,224, filed on Jul. 21, 2015.

(51) Int. Cl. H04W 48/16; H04W 76/06; H04W 76/02; H04W 74/04; H04W 68/12

(52) U.S. Cl. CPC H04W 48/16; H04W 74/04; H04W 68/12; H04W 76/02; H04W 76/06; H04W 84/18

(57) ABSTRACT

Methods, systems, and devices are described for presence indication and determination in a wireless data link, such as a neighbor aware network (NAN) data link (NDL). A wireless station (STA) may identify a set of devices associated with the wireless data link and transmit a message to the set of devices including a presence request indicator. The STA may determine that a first subset of the set of devices are present in the wireless data link based on receiving a response to the message from the first subset. The STA may also determine that at least one device of the set of devices are absent from the wireless data link based on receiving a notice of absence message from the one device.

### CROSS-REFERENCE

The present application for patent claims priority to U.S. Provisional Patent Application No. 62/195,224 by Patil, et al., titled “NEIGHBOR AWARE NETWORK DATA LINK PRESENCE INDICATION,” filed Jul. 21, 2015, and assigned to the assignee hereof.

### BACKGROUND

Field of the Disclosure

The present disclosure, for example, relates to wireless communication systems, and more particularly to wireless station presence determination in a neighbor aware network data link.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (Institute of Electrical and Electronic Engineers (IEEE) 802.11) may include an access point (AP) that may communicate with wireless stations (STAs) or mobile devices. The AP may be coupled to a network, such as the Internet, and enable a mobile device to communicate via the network (and/or communicate with other devices coupled to the access point). STAs may communicate directly via a wireless mesh or peer-to-peer (P2P) network where STAs may form a network without base station, APs, or other equipment. One example of a P2P network includes a cluster of STAs includes a synchronized wireless cluster, also referred to as a neighbor aware network (NAN).

A subset of STAs of the NAN may form a wireless data link to support communications for the NAN, also referred to as a NAN data link or NDL. NDL networks are dynamically self-organized and self-configured with STAs in the network automatically establishing an ad-hoc network with other STAs such that the network connectivity can be maintained. In an NDL, each STA or node relays data for the network and all stations cooperate in the distribution of data within the network. As a result, a message in the data link network can be transmitted from a provider STA to the destination STA by being propagated along a path, hopping from one STA to the next until the destination is reached. STAs participating in the NDL may be unavailable, e.g., lost connectivity due to mobility or may be unable to participate in NDL communications due to scheduling conflicts. The NDL network may not support beaconing operations and, therefore, the STAs may not be aware that the unavailable STAs are absent from the NDL.

### SUMMARY

The present disclosure relates to improved systems, methods, and/or apparatuses for presence indication and awareness in a neighbor aware network (NAN) data link (NDL). In particular, the present disclosure is directed to a wireless station (STA) or node of an NDL determining the presence of other STAs or nodes of the NDL. In some examples, the STA may identify the STAs of the NDL and send (or broadcast) a message to the devices in the NDL. The message may include a presence request indicator that signals to the other STAs to acknowledge their presence in the NDL. The STA may determine the presence of the other STAs of the NDL based on receiving a response confirming their presence. For example, the presence request indicator may be a traffic indicator and the response from the other STAs of the NDL may be a quality of service (QoS) NULL frame. The STA may receive the response(s) and identify the STAs of the NDL that are present, and by extension which STAs of the NDL are absent (e.g., STAs not responding).

Additionally or alternatively, the present disclosure also provides a method for presence detection based on receipt of a notice of absence message. For example, a STA of an NDL may determine that it will be unavailable for NDL communications, e.g., temporarily or permanently unavailable. The STA may transmit or broadcast a message to other STAs of the NDL that conveys the notice of absence indication. In instances where the STA is participating in multiple NDLs, the notice of absence message may be used by STAs within each NDL to determine the presence (or absence) of the STA. The notice of absence message may also include timing information indicating when the STA will be absent from the NDL. A STA of the NDL receiving the notice of absence message may determine that the transmitting STA will be absent from the NDL.

A method for wireless communication is described. The method may include: identifying a set of devices associated with a wireless data link; transmitting a message comprising a presence request indicator to the set of devices; and determining that a first subset of the set of devices are present in the wireless data link based at least in part on receiving a response to the message from the first subset.

The wireless data link may include a neighbor aware network (NAN) data link (NDL). The set of devices associated with the wireless data link are a subset of devices of a NAN cluster and are time synchronized according to a beaconing operation associated with the NAN. The wireless data link is associated with a schedule, the schedule may include a repeating set of time-blocks that may occur between consecutive NAN discovery windows. In some cases, the repeating set of time blocks may repeat periodically and may indicate periodicity. In other cases, the repeating set of time blocks may not repeat periodically and may indicate aperiodicity. A portion of the schedule may include at least one of the time-blocks. The presence request indicator conveys a request of whether the set of devices are present during at least one time-block.

The method may include: monitoring a transmission from a second subset of the set of devices; and determining that the second subset of the set of devices are present based at least in part on the monitored transmission. Monitoring the transmission may include monitoring the wireless data link. Monitoring the transmission may include monitoring at least one other wireless data link associated with a common synchronized wireless network cluster. The common synchronized wireless network cluster is a neighbor aware network (NAN) cluster. The method may include refraining from transmitting a message comprising the presence request indicator to the second subset of the set of devices based at least in part on the monitored transmission.

Transmitting the message may include transmitting a paging message to the set of devices, the paging message may include an indicator, wherein at least a portion of the indicator conveys the presence request indicator. The indicator may include a first set of information elements, each information element associated with a corresponding device of the set of devices and conveying the presence request indicator. The indicator may include a second set of information elements, each information element associated with a corresponding device of the set of devices having traffic to be communicated. The method may include sending, during a second portion of the transmission window, traffic to the devices of the set of devices having traffic to be communicated. The indicator may include at least a traffic indicator map, or a bloom filter representing the set of devices, or a list of medium access control (MAC) addresses representing the set of devices, or combinations thereof. The traffic indicator map (TIM) may include at least one TIM element as defined in IEEE 802.11 standard. The method may include: transmitting the message during a paging window associated with the wireless data link; and receiving the response during a first portion of a transmission window associated with the wireless data link.

The response may include a quality-of-service (QoS) NULL frame to convey an indication that the first subset of the set of devices are present in the wireless data link. The paging window may include a time associated with the wireless data link where the set of devices are in an active state. The method may include: receiving the response from at least one device of the first subset of devices, the response being received responsive to the at least one device receiving the message; and receiving other messages from other devices of the set of devices of the wireless data link.

The method may include selecting a contention window size associated with receiving the response from the first subset. The contention window size is selected to prioritize transmissions of the response to the message from the first subset during a transmission window associated with the wireless data link. Prioritizing transmissions of the response to the message may comprise prioritizing responses associated with a traffic announcement message and an indicator of presence, or a combination thereof. The method may include sending more than one message to the set of devices prior to determining that at least one device of the set of devices are absent in the wireless data link. The more than one message is sent according to a predefined time schedule.

The method may further includes identifying the set of devices may include identifying a data link identifier associated with the wireless data link. Identifying the set of devices may include identifying a security key associated with the wireless data link. The method may include determining, based on receiving the response to the message from the first subset, that the first subset of the set of devices are present in the wireless data link during a current time-block and at least one future time-block associated with the wireless data link. The response to the message received from the first subset may include an indication of a time-block the first subset is present in the wireless data link.

The method may include determining, based on receiving the response to the message from the first subset, that the first subset of the set of devices are present in the wireless data link, and receiving an indication of a time value associated with a disassociation period, the time value being equal to a period of time in which at least one device associated with the first subset of the set of devices is allowed to be inactive while present in the wireless data link. In some examples, the time value may be the maximum amount of time a peer device will remain in the wireless data link (or assign resources to the wireless data link), even if another peer in the first subset of the set of devices is inactive. In some examples, the method may further include releasing resources associated with the NDL when the time value satisfies a pre-determined threshold. In some examples, receiving the indication of the time value further comprises maintaining resources assigned to the NDL; and requesting a status of a second device of the first subset of the set of the devices. In some examples, requesting the status comprises requesting an indication of presence, a request to release resources if the NDL is no longer active, a request to reestablish communication with the second device, or requesting reassignment of the null data packet (NDP) to another device in the first subset of the set of devices.

A method for wireless communication is described. The method may include: identifying a set of devices associated with a wireless data link; receiving a notice of absence message from at least one device of the set of devices, the notice of absence message conveying an indication that the device is not present in the wireless data link during a portion of a schedule associated with the wireless data link; and determining, based on the received notice of absence message, that the device is absent in the data wireless data link.

The wireless data link may include a neighbor aware network (NAN) data link (NDL). The set of devices associated with the wireless data link are a subset of devices of a NAN cluster and are time synchronized according to a beaconing operation associated with the NAN. The schedule associated with the wireless data link may include a repeating set of time-blocks that may occur between consecutive NAN discovery windows. The portion of the schedule may include at least one of the time-blocks. The method may include receiving the notice of absence message during a NAN discovery window associated with the NDL. The notice of absence message may include an indication that the device is not present in at least one other wireless data link during the portion of the schedule.

In some embodiments, the notice of absence message may be received during a paging window associated with the NDL. In other embodiments, the notice of absence message may be received during a NAN discovery window associated with the NDL, wherein the received notice of absence message indicates absence from at least one NDL. When the notice of absence message is received during the NAN discovery window, the device refrains from participating in at least one NDL for a pre-determined period of time. In some embodiments, the notice of absence message is received during at least one time-block associated with the NDL. In some cases, when the notice of absence message is received during the time-block, the notice of absence message may indicate absence in the associated NDL.

The method may include determining, based on receiving the response to the message from the first subset, that the first subset of the set of devices are present in the wireless data link, and receiving an indication of a time value associated with a disassociation period, the time value equal to a period of time in which at least one device associated with the first subset of the set of devices is allowed to be inactive. The time value may be transmitted from at least one device associated with the first subset of the set of devices in a service discovery message. The time value may be communicated between devices within the first subset of the set of devices in the NDL. In addition, the time value may be increased when a packet is received during the period of time in which at least one of the devices associated with the first subset of the set of devices is allowed to be inactive.

The method may include receiving a packet during the period of time in which at least one device associated with the first subset of the set of devices is inactive; and adjusting the time value based in part on the receiving. Adjusting the time value may include increase and/or decreasing the time value.

Identifying the set of devices may include identifying a data link identifier associated with the wireless data link. Identifying the set of devices may include identifying a security key associated with the wireless data link.

An apparatus for wireless communication is described. The apparatus may include: an neighbor aware network (NAN) data link (NDL) set manager to identify a set of devices associated with a wireless data link; a presence indication manager to transmit a message comprising a presence request indicator to the set of devices; and a presence determination manager to determine that a first subset of the set of devices are present in the wireless data link based at least in part on receiving a response to the message from the first subset.

The wireless data link may include an NDL. The set of devices associated with the wireless data link are a subset of devices of a NAN cluster and are time synchronized according to a beaconing operation associated with the NAN. The presence indication manager is further to monitor a transmission from a second subset of the set of devices; and wherein the presence determination manager is further to determine that the second subset of the set of devices are present based at least in part on the monitored transmission. The presence indication manager to monitor the transmission is further to monitor the wireless data link. The presence indication manager to monitor the transmission is further to monitor at least one other wireless data link associated with a common synchronized wireless network cluster.

The presence indication manager is further to refrain from transmitting a message comprising the presence request indicator to the second subset of the set of devices based at least in part on the monitored transmission. The presence indication manager to transmit the message is further to transmit a paging message to the set of devices, the paging message may include an indicator, wherein at least a portion of the indicator conveys the presence request indicator. The indicator may include a first set of fields or bits. In some examples, the fields or the bits may be information elements, where each information element associated with a corresponding device of the set of devices and conveying the presence request indicator. The indicator may include a second set of information elements, each information element associated with a corresponding device of the set of devices having traffic to be communicated. The indicator may include at least a traffic indicator map, or a bloom filter representing the set of devices, an announcement traffic indication message (ATIM), or a list of MAC addresses representing the set of devices, or combinations thereof.

The presence indication manager is further to transmit the message during a paging window associated with the wireless data link; and wherein the presence determination manager is further to receive the response during a first portion of a transmission window associated with the wireless data link.

An apparatus for wireless communication is described. The apparatus may include: a neighbor aware network (NAN) data link (NDL) set manager for identifying a set of devices associated with a wireless data link; a presence indication manager for receiving a notice of absence message from at least one device of the set of devices, the notice of absence message conveying an indication that the device is not present in the wireless data link during a portion of a schedule associated with the wireless data link; and a presence determination manager for determining, based on the received notice of absence message, that the device is absent in the wireless data link.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows an example of a wireless communication subsystem for presence indication and determination in a wireless data link, in accordance with various aspects of the present disclosure;

FIG. 3 shows a timing diagram for presence indication and determination in a wireless data link, in accordance with various aspects of the present disclosure;

FIG. 4 shows an example of communications in a wireless data link, in accordance with various aspects of the present disclosure;

FIG. 5 shows an example of communications in a wireless data link, in accordance with various aspects of the present disclosure;

FIG. 6 shows a block diagram of a wireless station (STA) configured for use in wireless communication, in accordance with various aspects of the present disclosure;

FIG. 7 shows a block diagram of a STA configured for use in wireless communication, in accordance with various aspects of the present disclosure;

FIG. 8 shows a block diagram of a wireless communication system, in accordance with various aspects of the present disclosure;

FIG. 9 is a flow chart illustrating an example of a method for wireless communication, in accordance with various aspects of the present disclosure;

FIG. 10 is a flow chart illustrating an example of a method for wireless communication, in accordance with various aspects of the present disclosure; and

FIG. 11 is a flow chart illustrating an example of a method for wireless communication, in accordance with various aspects of the present disclosure.

### DETAILED DESCRIPTION

The described features generally relate to improved systems, methods, and/or apparatuses for presence indication and determination in a wireless data link. In accordance with the present disclosure, a wireless data link may be implemented to support communications for a neighbor aware network (NAN), also referred to as a NAN data link or NDL. In some examples, a wireless data link may be a fully connected network in which each member wireless station (STA) has a connection with every other STA in the network. Also, a wireless data link may be a partially connected network in which some member STAs may be connected in a full connectivity scheme, but other member STAs are only connected to some of the STAs, but not all of the member STAs of the network. Further, a wireless data link may extend the capabilities of a Wi-Fi framework to enable participating STAs to establish link connectivity for content delivery. In some examples, at least one participating STAs may form a wireless communication link for content delivery, e.g., transmitting STA(s) delivering content for at least one receiving STA.

Wireless data link networks may be used for static topologies and ad-hoc or NAN. The described techniques may be applied to various mesh network topologies and/or other P2P networks. A network may comprise a plurality of STAs or nodes, each of which can be capable of relaying data within the network on behalf of other devices in an NDL environment. The data transmitted or relayed between the STAs may similarly create a data path (“DP”) wherein the “path” describes the data flow from one STA to another. Accordingly, an NDL may comprise data transferred from a service provider to a service consumer.

A wireless data link may include more than one “hop.” A “hop” as used herein depends on the number of STAs between the STA providing the service (provider STA) and the STA consuming the service or “subscribing” (subscriber STA) to the service. For example, a service that is relayed by one STA may be referred to as two hops: provider STA (hop one) to proxy STA, (hop two) to seeker STA. While a wireless data link may refer to a subset or network of devices capable of one-hop service discovery, a wireless data link may be capable of service discovery and subscription over multiple hops (multi-hop).

In certain embodiments, a group or a “set” of STAs may connect to form an NDL. An NDL set may generally refer to a subset of a NAN cluster that shares a common timing parameters, e.g., a common paging window (PW) that precedes a common data transmission window (TxW). The TxW for the NDL group may have common security credentials for each of the STAs, which may serve to restrict membership within the NDL. Accordingly, a restricted NDL may require out-of-band credentialing. Each NDL may also be associated with a unique identifier, such as an NDL ID, that distinguishes NDL groups from each other. In some instances, the TxW for a first NDL may be the same or different from a TxW for a second NDL.

In some examples, a wireless data link may be formed between a first STA and at least one second STAs to provide services to the first STA. To establish a network for the above-referenced communication, the first STA may discover or otherwise become aware of a second STA in the network. In some examples, the second STA may provide a desired service, e.g., access to the Internet or music streaming. As a result, the first STA may request content delivery of the desired service(s) by propagating a request in the network to the second STA. In response, a second STA may transmit a traffic announcement message to the first STA during a paging period to inform the first station that the second STA has pending data for transmission.

In an NDL network, the set of devices generally share a common timing synchronization. For example, the set of devices of the NDL may be a subset of devices belonging to a NAN. The NAN typically uses a beaconing operation to time align the NAN member devices. As a result, the subset of devices of the NDL are synchronized. Therefore, the NDL typically does not include a beaconing operation. While the NAN beaconing operation may synchronize the set of devices of the NDL, the absence of a beaconing operation in the NDL may result in presence indication and determination difficulties. For example, a member STA of the NDL may not be aware when other member STA(s) become unavailable, e.g., due to STA mobility, scheduling conflicts, etc.

In accordance with the present disclosure, a method for presence indication and determination in a wireless data link network or NDL is described. Specifically, the present disclosure may provide a method for a member STA to ascertain whether other NDL member STA(s) are present or absent from the wireless data link. For example, the member STA may send a presence request indicator to the other member STAs. The other member STAs that are present in the NDL and receive the message may respond by sending a message to the member device. The member STA may receive the response messages and determine which of the other member STAs are present in the NDL. Conversely, the member STA may also determine which member STAs are absent from the NDL. In some examples, the presence request indicator may be sent in a traffic indicator to the other member STAs during a PW of the wireless data link. The response may, in some examples, be sent in a TxW of the wireless data link and the other member STAs may send a quality of service (QoS) NULL to the member STA. In some examples, the member STA may monitor or “sniff” the wireless data link to detect transmissions from the other member STAs. For transmissions detected from other member STAs, the member STA may determine that those STAs are present in the wireless data link and therefore refrain from sending a presence request indicator to those STAs.

In some embodiments, detecting the presence of an STA may be enabled or facilitated by a traffic advertisement or indicator. For example, a first STA may be programmed to ascertain whether a second STA is present. The first STA may also have traffic (e.g., at least one packet) to send to a third STA. Thus, the first STA may transmit a traffic advertisement indicating traffic for the second and the third STAs. If the second STA is present, the second STA will acknowledge (or send a trigger) the traffic advertisement to the first STA based on receiving the traffic advertisement. In some examples, the first STA may send a NULL frame to the second STA which may indicate that the first STA does not have traffic to send, but is requesting an indication of presence. In contrast, in some examples, the third STA may transmit an acknowledgement (or a trigger) to the first STA indicating receipt of the traffic advertisement. In response, the first STA may then transmit traffic to the third STA.

Additionally or alternatively, the present disclosure may also provide a method for presence indication and determination in a wireless data link network or NDL. For example, another member STA of the wireless data link may determine that it will be unable for NDL communications for a certain period, e.g., due to scheduling conflicts, etc. Accordingly, the other member STA may send a notice of absence message. The notice of absence message may provide the indication that the other member STA will be absent from the NDL for the time period. The remaining member STAs of the NDL may receive the notice of absence message and determine that the other member STA will be absent from the NDL for the time period. The notice of absence message may be sent during a discovery window associated with the wireless data link. When the other member STA is communicating in multiple NDLs, the notice of absence message may indicate that the other member STA will be absent from the other NDLs also.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

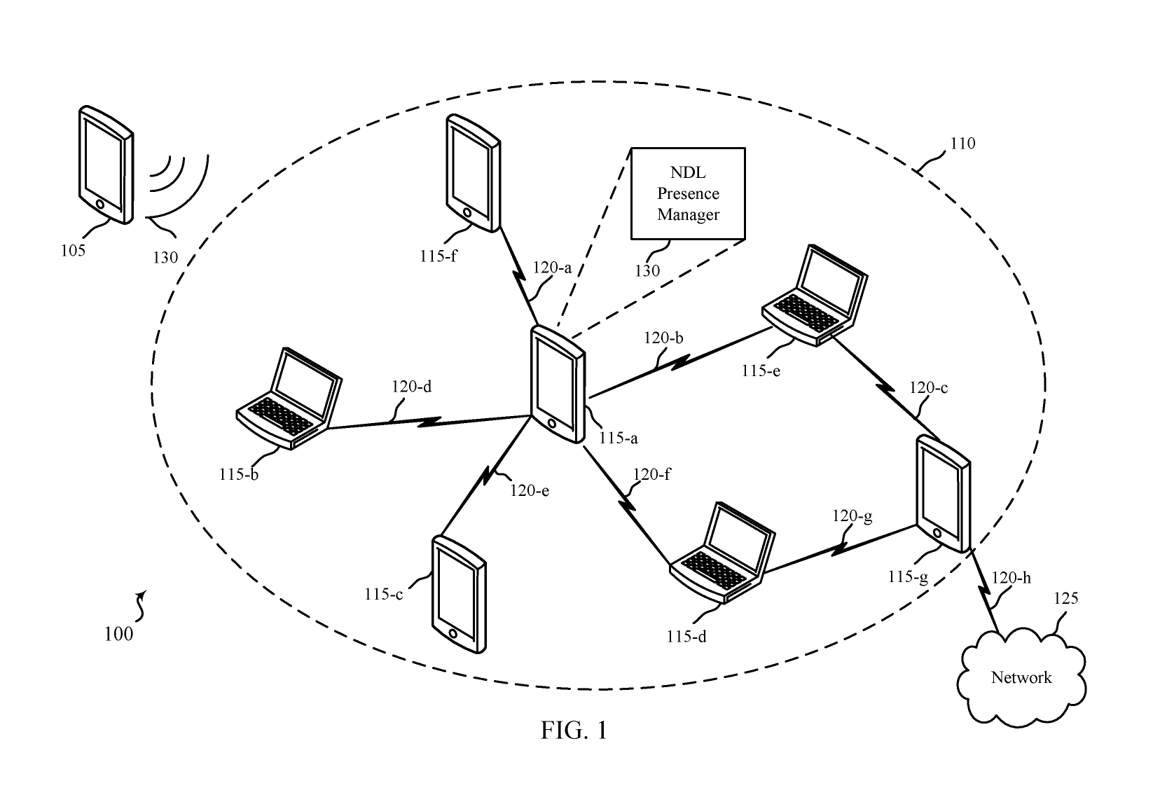

FIG. 1 illustrates a WLAN network 100 (also referred to as a wireless data link, a data link network, or NDL) configured in accordance with various aspects of the present disclosure. The WLAN network 100 includes an established NDL network 110. The NDL network 110 may be implemented as a wired or wireless communication network of various fixed and/or mobile devices that may be referred to as “nodes” or “STAs” 115. Each of the STAs 115 may receive and communicate data throughout the NDL network 110, such as throughout a college campus, metropolitan area, community network, and across other geographic areas. A STA 115 may also function to route data from one STA to another within the NDL network 110. In addition, each STA 115 may typically have more than one communication link to and/or from other STAs 115 of the NDL network 110, which provides for redundant communication links and a reliable communication system. For instance, STA 115-a may establish communication with STA 115-g via either intermediate STA 115-d or 115-e respectively. In some examples, at least one STAs 115 may include NDL presence manager 130 to perform the functionalities of the present disclosure for presence indication and determination in the NDL network 110.

As shown in FIG. 1, the NDL network 110 can be a partially connected network, with connections or communication links 120 established between the STAs 115-a through 115-g such that each of the STAs may communicate with all of the other STAs of the NDL network 110, some directly and some indirectly. The NDL network 110 may be connected to an external network 125, such as the Internet, by at least one member device (e.g., STA 115-g in this example) establishing a connection or communication link 120 with the external network 125. Although not shown, the STA 115-g may establish its connection with a base station or access point that has access to the external network 125.

The wireless NDL network 110 may include various STAs 115 implemented for wireless communication utilizing a data packet routing protocol, such as Hybrid Wireless Mesh Protocol (HWMP) for path selection. In some examples, the NDL network 110 may also be implemented for data communication with other networks that are communicatively linked to the network, such as with another wireless network, wired network, wide-area-network (WAN), and the like.

In the wireless NDL network 110, communication links 120 may be formed between the various STAs 115 of the NDL network 110. The data packets for wireless communication in the network may be forwarded or routed from a source STA (e.g., transmitting node) to an originator STA (e.g., receiving node) via intermediate STA(s), which are commonly referred to as “hops” in a multi-hop wireless NDL network 110. For instance, communication from a first STA 115-a to second STA 115-f via communication link 120-a may be considered “one-hop.” Similarly, communication between a first STA 115-a to a third STA 115-g via intermediate STA 115-e and communication links 120-b and 120-c may be considered “two-hops” for the purpose of this disclosure. Communication between multiple STAs 115, however, is not limited to either one or two hops, and may comprise any number of hops required for establishing communication between a plurality of STAs 115 via the selected path.

In one example, wireless communication device 105 may be in proximity of the NDL network 110. The wireless communication device 105 may join the NDL network 110 by authenticating with only one of the member STAs 115 of the existing NDL network 110. Upon successfully completing an authentication procedure, the wireless communication device 105 may receive a group key common to the devices of the NDL network 110 and use the common group key to discover the topology of the existing NDL network 110 by sending a route request message to the other STAs 115 and receiving route reply messages from other STAs 115. Based on the received route reply messages, the wireless communication device 105 may determine a topology of the NDL network 110 and, accordingly, determine a route or path to a provider STA 115 of the NDL network 110 providing a desired service.

Member STA 115-a (e.g., STAs 115-f and 115-e) may request content delivery (e.g., music streaming) from source STA (e.g., 115-b and 115-c) of the NDL network 110. In some examples, the source STAs 115-b and 115-c may advertise NDL parameters as part of the service advertisements. The parameters may include attributes regarding the NDL network 110, including identifying when the transmission window (TxW) starts, start time offset between consecutive TxWs, the size of the TxW, the size of the paging window (PW), and the time slots associated with each of the PW and the TxW. In some examples, a STA 115 desiring to participate in the content delivery may form an NDL for the purposes of the content delivery, wherein the STAs 115 of the NDL network 110 may share a common transmission window timing. Based on the advertised parameters, each of the source STAs (e.g., 115-b and 115-c) may transmit a traffic announcement message to receiver STAs 115-f and 115-e during a PW. The traffic announcement may identify at least one receiver STA 115 (i.e., 115-f and/or 115-e) and indicate that the source STA(s) (i.e., 115-b and/or 115-c) have pending data for at least one receiver STAs 115-f and/or 115-e.

In one configuration, a member STA of the NDL network 110 may determine the presence of the other member STAs 115 on the NDL network 110. For example, communications over the NDL network 110 may have been silent for a given time period and therefore the member STA 115 (e.g., STA 115-a) may determine whether any of the other member STAs 115 have left and are therefore absent from the NDL network 110. Accordingly, the member STA 115 may identify the other member STAs 115 of the NDL network 110 (e.g., identify STAs 115-b to 115-g). The member STA 115 may send a message to the other member STAs 115 of the NDL network 110. The message may include a presence request indicator that instructs the other member STAs 115 to respond and confirm their presence on the NDL network 110. The other member STAs 115 that receive the message with the presence request indicator may respond by sending a message to the member device. In the circumstance where the member STA 115 has data to be transmitted to other member STAs 115, the member STA 115 may send a traffic announcement message to these STAs 115 and omit them from the presence request indicator message. The member STA 115 may, instead, rely on confirmation messages from these STAs 115 to confirm that they are present in the NDL network 110. The member STA 115 may also monitor the NDL network 110 for transmissions from the other member STAs 115 to determine whether they are present on the NDL network 110.

Additionally or alternatively, the member STA 115 may determine whether other member STAs 115 are present on the NDL network 110 based on receiving a notice of absence message. For example, one other member STA 115 may determine that it will be absent from the NDL network 110 and send a notice of absence message to the remaining member STAs 115 of the NDL network 110. The member STA 115 may receive the notice of absence message and determine that the other member STA 115 is absent from the NDL network 110.

Additionally or alternatively, the member STA 115 may disassociate from the NDL network 110 after waiting for a pre-determined period (e.g., a disassociation period), where disassociation may indicate that the member STA 115 has relinquished NDL resources, the connection to the NDL network 110 is lost, or a combination thereof. For example, the disassociation time value may be a value transmitted as part of a service discovery, negotiated as part of an NDL setup, indicated in communications by a peer device in the NDL network 110 when the NDL network 110 is active, or some combination of these.

If the communication link between member STAs is inactive during the disassociation period, at least one of the STAs may leave the NDL network 110 with or without transmitting a notification message (i.e., an NDL disassociate message). In some cases, if any packet is received during the disassociation period, the disassociation period may be extended or adjusted. In some examples, the communication link may be between just two STAs.

In other embodiments, regardless of the presence or absence of traffic during the disassociation period, a member STA 115 may wish to keep the NDL active during the disassociation period. Thus, the member STA 115, may transmit and/or receive periodic transmissions during the disassociation period to extend the length of the period. Thus, the member STA 115 may continue to maintain the resources that the STA has been assigned for the NDL during the disassociation period.

In another embodiment, a first member STA (e.g., 115-d) may query another member STA (e.g., 115-g) present in the NAN to determine the status of example member STA 115-g. STA 115-g may send a response to STA 115-d which indicates presence of the STA-g in the NDL network 110. The response may also indicate a request to release resources if the NDL is no longer active. The response may further indicate a request to re-establish a communication link between the STAs (and further may initiate or establish the communication link), if one of the other STAs has disassociated. In another embodiment, STA 115-g may reassign an identifier originally assigned to STA 115-g to STA 115-d. In this case, the STA 115-g may cease reacting to or responding to traffic advertisements or queries associated with the identifier based on the reassignment of the identifier. In some examples, the identifier may be an identifier associated with the data session (e.g., an NDP ID).

In another embodiment, a first STA which receives a disassociation time value may use the time value to ensure transmissions are kept “alive” with the first STA in absence of any traffic data which may be otherwise available for transmission. Thus, the first STA may continue to maintain the resources it is assigned for the data link connection. The first STA may transmit another message to a second STA to check on the status of the second STA. In some examples, the query may request an indication of presence, a request to release resources if the data link is no longer active, to re-establish communication between the first and second STAs, or to request reassignment of the NDP to another STA. In some embodiments, these queries may be used when there is no expiration or life time set for the data link.

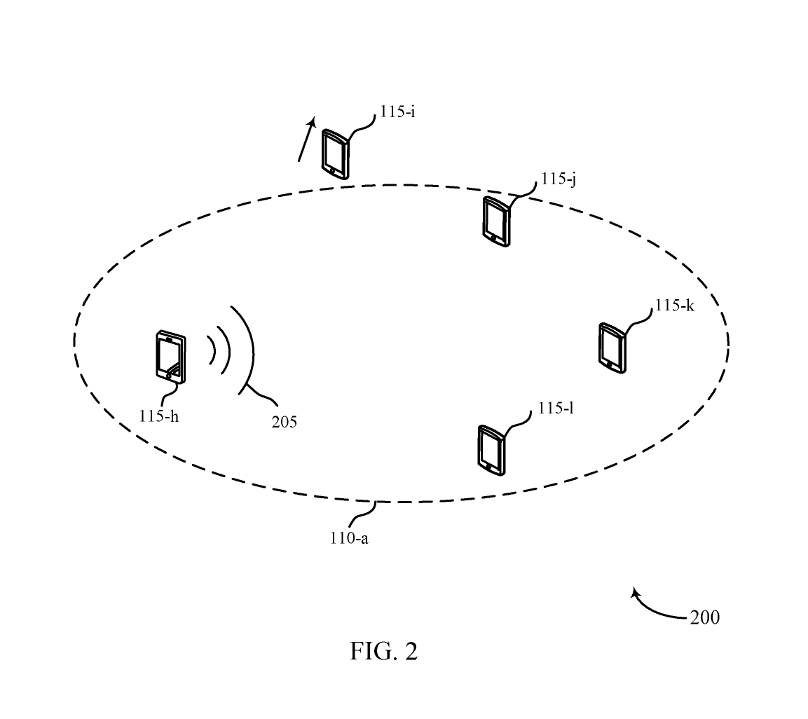

FIG. 2 illustrates an example of a wireless communication subsystem 200 for presence indication and determination in a wireless data link or NDL in accordance with various aspects of the present disclosure. Wireless communication subsystem 200 may include STAs 115-h, 115-i, 115-j, 115-k, and 115-l, which may be an example of a STA 115 described above with reference to FIG. 1. The wireless communication subsystem 200 may further include an established NDL network 110-a, which may be an example of an NDL network 110 with reference to FIG. 1.

The present disclosure provides a method for a STA 115 to determine whether the other member STAs 115 are present or absent in the NDL network 110-a. The described techniques may identify route failures within the NDL network 110-a. In the circumstance where one STA 115 is acting as a proxy for a second STA 115 by sending service announcement messages on behalf of the second STA 115, the described techniques may prevent such proxy announcements when the second STA 115 is absent from the NDL network 110.

Generally, the NDL network 110-a may include a set of STAs 115 (e.g., STAs 115-h to 115-l) that are associated with a synchronized wireless NAN cluster. The STAs 115 of the NDL network 110-a may be synchronized based on beaconing operations of the NAN cluster and may transition to an active state during a synchronized PW to send or receive traffic announcements. STAs 115 that have no traffic to send or receive transition to a sleep state during the TxW. The traffic announcements may be sent in a paging message during the PW. The traffic announcements for member STAs 115 may be conveyed in a traffic indicator map (TIM) which includes bits in a bitmap associated with member STAs 115 with pending traffic, in a bloom filter that provides a space-efficient MAC listing of the member STAs 115 with pending traffic, in a MAC address listing for the member STAs with pending traffic, or other mechanisms. The paging message may be conveyed in a public action frame (PAF), a service discovery frame (SDF), a NAN management frame (NAF), or some other frame structure.

In aspects of the present disclosure, a member STA 115 (e.g., STA 115-h) may utilize a mechanism similar to a traffic announcement to determine whether, and which of, the other member STAs 115-i, 115-j, 115-k, and 115-l, are present on the NDL network 110-a. The STA 115-h may transmit (or broadcast) a message 205 to the other member STAs 115 that includes a presence request indicator. The presence request indicator may be sent in a paging message during the PW. The presence request indicator may utilize a PAF, a SDF, or some other frame to carry an indication (e.g., a list) of which of the other member STAs 115 that member STA 115-h is requesting a presence indication. In some examples, the presence request indicator listing may be sent in addition to, or as a component of, a traffic indicator map that identifies the other member STAs 115 having pending traffic. The other member STAs 115 having pending traffic may be omitted from the presence indicator listing and instead may confirm their presence by acknowledging their respective traffic announcement. The member STA 115-h may listen or “sniff” the NDL network 110 to identify the presence of some of the other member STAs 115, e.g., monitor for transmissions from the other member STAs 115.

The other member STAs 115 that have received a presence indicator may respond by sending a message to the member STA 115-h. The response message may be a trigger that can be sent at the beginning portion of the TxW and indicates their presence in the NDL network 110-a. An example trigger may be a QoS NULL frame, a power-save polling (PS-Poll) frame, or some other frame. In one example, the responding other member STAs 115 may send a QoS NULL frame with a MORE bit (or end of service period (EOSP) bit) set to “0” for the member STA 115-h. The other member STAs 115 that have received the message including the presence request indicator may not have pending traffic. Other member STAs 115 that do not receive the message including the presence request indicator may not respond. In the example NDL network 110-a of FIG. 2, STA 115-i may be mobile and therefore have moved out of coverage area of the NDL network 110-a. Accordingly, member STA 115-h may not receive a response from STA 115-i.

Member STA 115-h may identify the subset of STAs 115 present in the NDL network 110-a based on received responses. In the example NDL network 110-a of FIG. 2, member STA 115-h may have identified the set of other member STAs 115-i to 115-l as being associated with the NDL network 110-a. Based on the received responses, member STA 115-h may identify a subset of the set of STAs 115 that does not include STA 115-i.

Other member STAs 115 of the NDL network 110-a may also be associated with other NDL networks and may also receive messages with presence request indicator from the other NDL networks. The other member STA 115 may respond by sending a single response message that indicates to each of the associated NDL network that the member STA 115 is present.

Member STA 115-h may, in some examples, transmit more than one message conveying the presence request indicator. For example, the member STA 115-h may transmit two, three, or some other presence request indicator messages before determining whether another member STA 115 is present or absent from the NDL network 110-a.

Member STA 115-h may modify a traffic indicator map (TIM) to convey the indication of traffic pending for some other member devices 115 and also the presence request indicator. For example, the bitmap of the TIM may include certain bits reserved for a traffic announcement and other bits reserved as a presence request indicator. Other examples may include a bitmap where two bits are associated with each other member STA 115. A first value for the two bits may be selected to convey the traffic announcement (e.g., “01”) and a second value of the two bits may be selected to convey the presence request indicator (e.g., “11”). Other examples may include indications conveyed in a bloom filter, MAC listing, etc., that distinguishes other member STAs 115 having pending traffic from the other member STAs 115 with a presence request indicator.

Some aspects may provide for responses from the other member STAs 115 to have lower priority with respect to triggers for traffic, e.g., responses to traffic announcements. For example, a time-block between the PW and the TxW may be reserved for presence request responses (e.g., triggers). In another example, a contention window size may be selected for presence request responses that results in a higher priority than for the traffic announce response triggers (and also a higher priority than for contention windows associated with data transmissions). For example, the contention window size for the presence request responses may be selected based on the number of STAs 115 of the NDL network 110-a, based on the number of other member STAs 115 receiving the presence request indicator, etc. In some embodiments, the contention window size for a presence request response may be a pre-determined and specifically dedicated length which differs than the contention window size for traffic announcements. In other embodiments, the contention window size for at least one presence request response may not be a specific length, but may be set relative to a contention window size associated with at least one traffic announcement. In some examples, the contention window size for at least one presence request response may be shorter than a contention window size associated with at least one traffic announcement. Because the contention window size for a presence request response may be shorter than a contention window size associated with at least one traffic announcement, in some examples, there is an increased probability that the presence request response will access the medium before a traffic announcement or a data frame.

In some embodiments, the contention window may determine a countdown value during which the transmitter may attempt to access the medium. A transmitter may select a random value between 0 and the contention window size. A higher value (e.g., a value closer to the contention window size and within a predetermined value range) may indicate a higher likelihood that other transmitter could be granted access to the medium before the first transmitter. For example, a first transmitter (e.g., associated with a first STA) may select a value of 256, whereas a second transmitter (e.g., associated with a second STA) may select a value of 64. In this example, there is a higher likelihood that the second STA will be granted access to the medium over the first STA.

The present disclosure also provides for use of a notice of absence message to indicate or determine the presence of member STAs 115 in the NDL network 110-a. For example, a first member STA 115 may determine that it will be absent from the NDL network 110-a. The first member STA 115 may be absent during a portion of a schedule associated with the NDL network 110-a, e.g., at least one time-block of a repeating set of time-blocks occurring during consecutive NAN discovery windows. Member STAs 115 receiving the notice of absence message may determine that the sending member STA 115 is absent from the NDL network 110-a, e.g., absent for the at least one time-block. The notice of absence message may be sent during a NAN discovery window, for example. In some embodiments, when the notice of absence message is received during the NAN discovery window, the STA 115 refrains from participating in at least one NDL for a pre-determined period.

Because multiple STAs may be participating in multiple NDLs associated with a common NAN cluster, a notice of absence message sent during the NAN discovery window may indicate the STA is absent in multiple NDLs. In other embodiments, a notice of absence message sent during a discovery window for a particular NDL may indicate absence only for the particular NDL.

In the situation where the member STA 115 sending the notice of absence message is associated with other NDL networks, the message may convey an indication to member STAs 115 of the other NDL networks that the sending STA 115 will be absent from the respective NDL network.

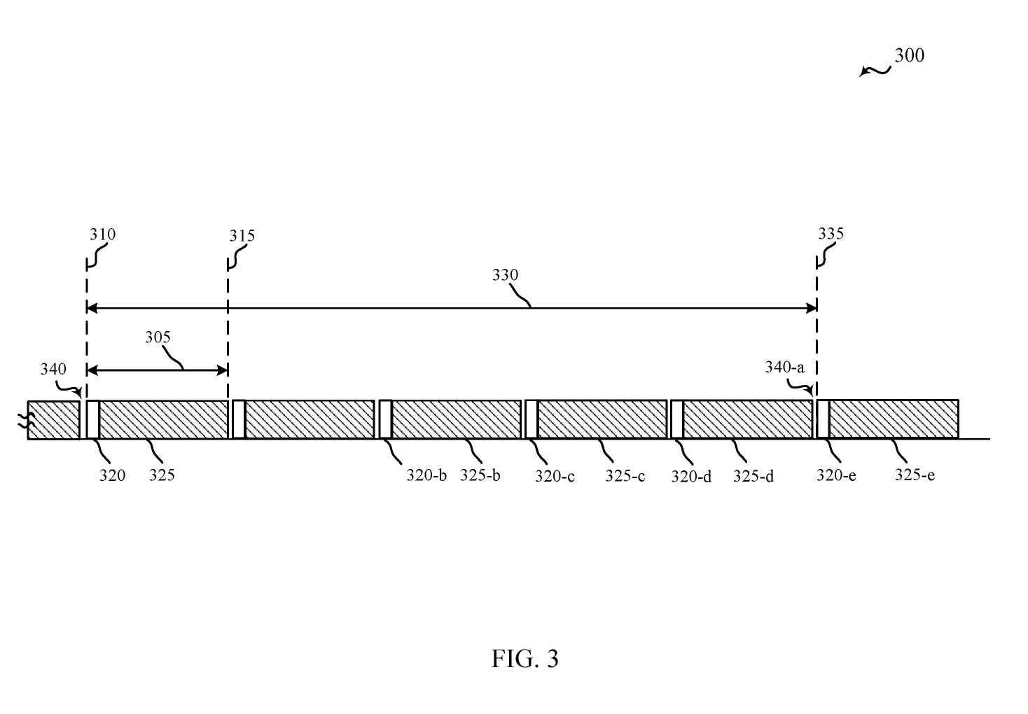

FIG. 3 shows a timing diagram 300 illustrating various timing aspects of the present disclosure, according to various embodiments. The timing diagram 300 may be implemented by at least one aspects of the STAs 115, described with reference to FIGS. 1 and/or 2.

The NDL network, such as NDL network 110 described with reference to FIGS. 1 and 2, may be a synchronized network, i.e., all of the participating STAs 115 may share a common timing reference to enable synchronized communications. Generally, the shared reference timing may include a data transmission window 305 (or time-block) and a discovery window 340. The data transmission window 305 may be defined as between times 310 and 315 and may include a paging period 320 (or PW) at the beginning of the data transmission window 305 as well as a data transmission period 325 (or TxW). Generally, the participating STAs 115 may wake up during the paging period 320 to listen to the paging channel to determine whether there is any traffic being sent to the STA 115. If there is traffic being sent, the STA 115 may remain awake during the data transmission period 325 to exchange the traffic (i.e., control or data information). If there is no traffic being sent, the STA 115 may transition back to a sleep state during the data transmission period 325 to conserve power.

The discovery window 340 may be a NAN discovery window and may occur during the time period between data transmission windows 305. In some embodiments, the discovery window 340 may not occur before every data transmission window 305 but may, instead, occur once per timing interval 330, e.g., between a predetermined number of paging periods 320. In the example shown in FIG. 3, the timing interval 330 may be defined as the time period between times 310 and 335.

Accordingly, the STA 115, once joined to the NDL network and synchronized via the beaconing operations of the associated NAN, may know when the data transmission window 305 occurs, and the associated paging period 320. As discussed previously, such NDL parameters may be advertised as part of the service advertisement by the provider and/or source STAs. In accordance with the present disclosure, the paging period 320 may be used for sending messages conveying the presence request indicator. The data transmission period 325 may be used by STAs responding to the presence request indicator, e.g., member STAs sending a trigger response. For example, member STAs sending a trigger responsive to the presence request indicator may send the trigger during an initial portion of the data transmission period 325 that follows the paging period 320 the presence request indicator was received. In some examples, the message including the presence request indicator may be transmitted in more than one paging period 320.

The notice of absence messages may be transmitted during the discovery window 340 by member STAs that will not be present during at least one data transmission window 305. The notice of absence message may convey an indication of which of the data transmission window 305 the sending STA will be absent from the NDL network. The notice of absence message may convey an indication that the sending STA will be absent for all of the data transmission windows 305 occurring during the timing interval 330. The notice of absence message may convey an indication that the sending STA will be absent for N subsequent timing intervals 330, where N is a positive integer.

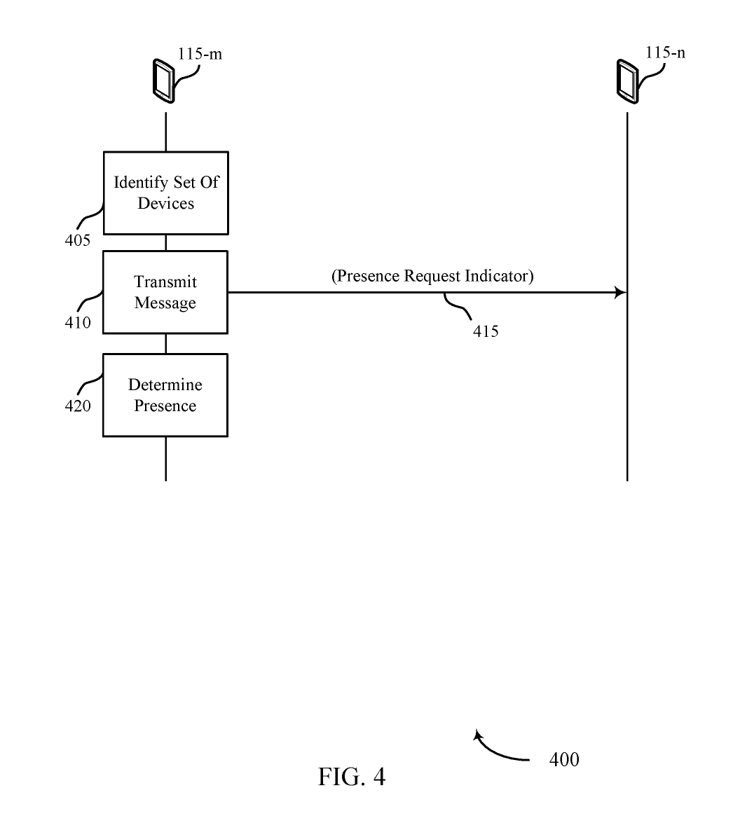

FIG. 4 shows an example diagram 400 of aspects of communications for use in wireless communication, in accordance with various aspects of the present disclosure. Diagram 400 illustrates communications between an STA 115-m and STA 115-n. STAs 115-m and 115-n may be an example of aspects of a STA 115 described with reference to FIGS. 1 and 2. STAs 115-m and 115-n may be member STAs of an NDL network, such as the NDL networks 110 described with reference to FIGS. 1 and 2. Generally, STA 115-m may seek to determine whether STA 115-n is present in the NDL network.

At 405, STA 115-m may identify a set of devices associated with the NDL network, e.g., a wireless data link. The set of devices may include STA 115-n and other member STAs 115. The member STAs 115 of the NDL network may be associated with a common NAN cluster and be synchronized using beaconing operations of the NAN cluster.

At 410, STA 115-m may transmit a message 415 to STA 115-n that includes a presence request indicator. The present request indicator may be conveyed in bit(s) of a TIM, in a bloom filter listing of MAC addresses, in a MAC address listing, in an ATIM frame, etc. The presence request indicator may include information identifying STA 115-n and requesting that STA 115-n confirm its presence in the NDL network. That is, the presence requestor indicator may include sufficient information to convey to STA 115-n that a response confirming its presence in the NDL network is being requested.

At 420, STA 115-m may determine the presence of STA 115-n based on receiving a response. STA 115-m may identify the subset of STAs 115 of the NDL based on receiving responses. For example, STA 115-n may send a response message responsive to receiving the presence request indicator and STA 115-m may add STA 115-n to a subset of STAs 115 of the NDL network that are present. Accordingly, STA 115-m may confirm the presence of STA 115-n, and other member STAs 115 of the NDL network, based on responses received from the present member STAs 115.

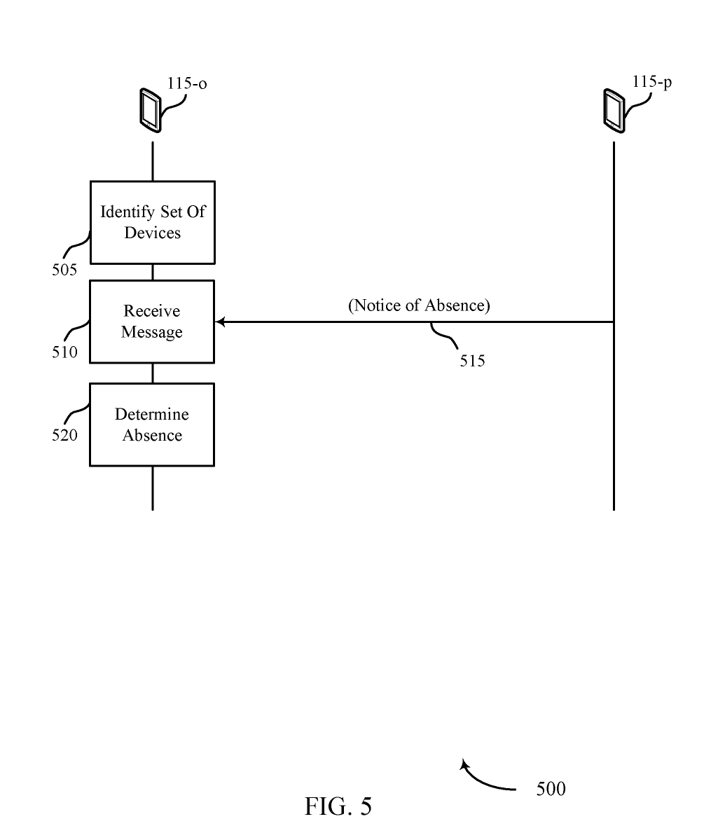

FIG. 5 shows an example diagram 500 of aspects of communications for use in wireless communication, in accordance with various aspects of the present disclosure. Diagram 500 illustrates communications between an STA 115-o and STA 115-p. STAs 115-o and 115-p may be an example of aspects of a STA 115 described with reference to FIGS. 1 and 2. STAs 115-o and 115-p may be member STAs of an NDL network, such as the NDL networks 110 described with reference to FIGS. 1 and 2. Generally, STA 115-o may determine whether STA 115-p is present in the NDL network based on receiving a notice of absence message. STA 115-p may be associated with other NDL networks.

At 505, STA 115-o may identify a set of devices associated with the NDL network, e.g., a wireless data link. The set of devices may include STA 115-p, and other member STAs 115. The member STAs 115 of the NDL network may be associated with a common NAN cluster and be synchronized using beaconing operations of the NAN cluster.

At 510, STA 115-o may receive a message 515 from STA 115-p that includes a notice of absence indicator. The message 515 may be received during a discovery window of the NAN cluster and may include an indication that STA 115-p may be absent from the NDL network for at least a time period, e.g., at least one data transmission window or time-block. When STA 115-o is associated with other NDL networks, the notice of absence message may also convey an indication that STA 115-p will be absent from those NDL networks.

At 520, STA 115-o may determine the absence of STA 115-p based on receiving the notice of absence message. STA 115-o may identify the subset of STAs 115 of the NDL based on receiving the notice of absence message, which may not include STA 115-p. Accordingly, STA 115-o may confirm the absence of STA 115-p, and other member STAs 115 of the NDL network, based on receiving notice of absence message(s) received from the absent member STAs 115.

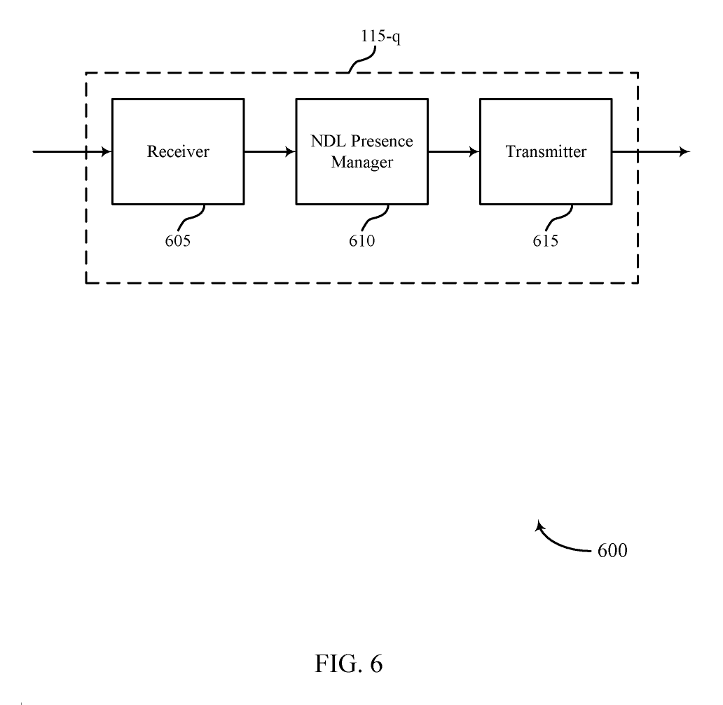

FIG. 6 shows a block diagram 600 of a STA 115-q for use in wireless communication, in accordance with various aspects of the present disclosure. In some examples, the STA 115-q may be an example of aspects of the STAs 115 described with reference to FIGS. 1-2 and 4-5. The STA 115-w may also be or include a processor (not shown). The STA 115-q may include a receiver 605, an NDL presence manager 610, and/or a transmitter 615. Each of these components may be in communication with each other.

The STA 115-q, through the receiver 605, the NDL presence manager 610, and/or the transmitter 615, may perform functions described herein. For example, the STA 115-q may be configured for presence indication and determination in an NDL network, such as a wireless data link.

The components of the STA 115-q may, individually or collectively, be implemented using at least one ASICs adapted to perform some or all of the applicable functions in hardware. Alternatively, the functions may be performed by other processing units (or cores), on at least one integrated circuits. In other examples, other types of integrated circuits may be used (e.g., Structured/Platform ASICs, field-programmable gate arrays (FPGAs), and other Semi-Custom ICs), which may be programmed in any manner known in the art. The functions of each component may also be implemented, in whole or in part, with instructions embodied in a memory, formatted to be executed by a general or application-specific processors.

The receiver 605 may receive information such as packets, user data, and/or control information associated with various information channels (e.g., control channels, data channels, etc.). The receiver 605 may receive responses to presence request indicator messages, notice of absence messages, etc., associated with presence indication and determination. Information may be passed on to the NDL presence manager 610, and to other components of the STA 115-q.

The NDL presence manager 610 may monitor, control, or manage aspects of presence indication and determination in an NDL network for the STA 115-q. For example, the NDL presence manager 610 may identify a set of STAs (or devices) associated with a wireless data link (e.g., the NDL network). The NDL presence manager 610 may transmit a message that includes a presence request indicator to the set of devices. The NDL presence manager 610 may determine that a first subset of the set of devices are present in the wireless data link based on receiving a response to the message from the first subset.

In other examples, the NDL presence manager 610 may identify a set of STAs (or devices) associated with a wireless data link (e.g., the NDL network). The NDL presence manager 610 may receive a notice of absence message from one of the devices of the set of devices. The notice of absence message may include an indication that the at least one device is not present in the wireless data link during a portion of a schedule associated with the wireless data link. The NDL presence manager 610 may determine, based on receiving the notice of absence message, that the one of the devices is absent from the wireless data link.

The transmitter 615 may transmit the at least one signals received from other components of the STA 115-q. The transmitter 615 may transmit messages including a presence request indicator, and the like, associated with presence indication and determination in an NDL network. In some examples, the transmitter 615 may be collocated with the receiver 605 in a transceiver component. The transmitter 615 may include a single antenna, or it may include a plurality of antennas.

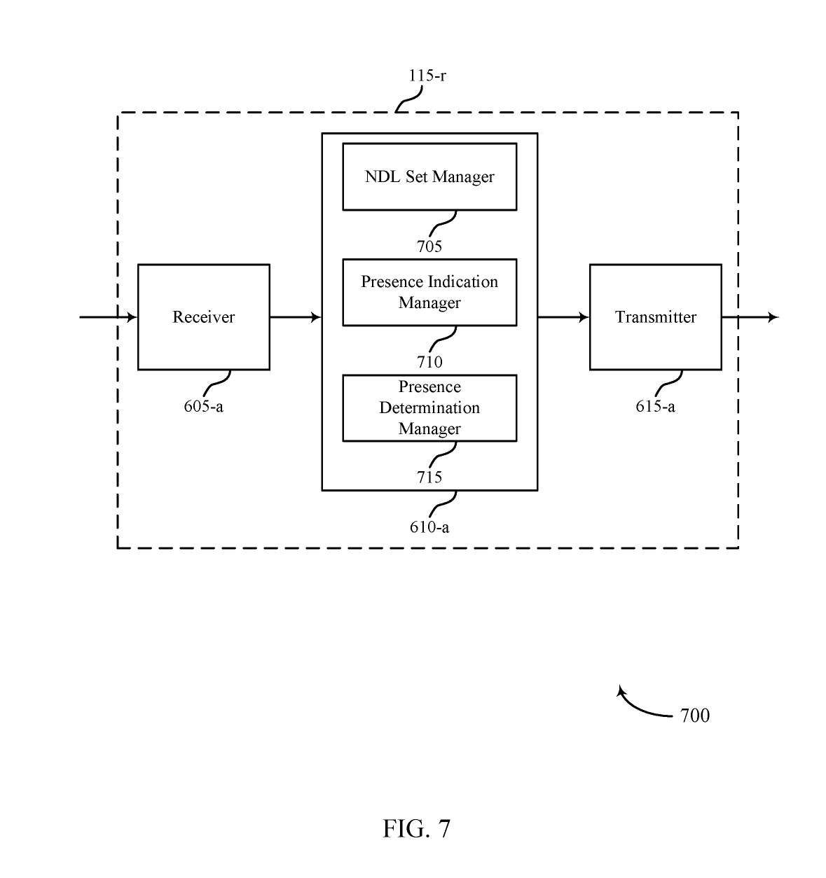

FIG. 7 shows a block diagram 700 of a STA 115-r for wireless communication, in accordance with various examples. The STA 115-r may be an example of aspects of a STA 115 described with reference to FIGS. 1-2 and 4-5. The STA 115-r may also be an example of a STA 115-q described with reference to FIG. 6. The STA 115-r may include a receiver 605-a, an NDL presence manager 610-a, and/or a transmitter 615-a, which may be examples of the corresponding components of STA 115-q. The STA 115-r may also include a processor (not shown). Each of these components may be in communication with each other. The NDL presence manager 610-a may include an NDL set manager 705, a presence indication manager 710, and/or a presence determination manager 715. The receiver 605-a and the transmitter 615-a may perform the functions of the receiver 605 and the transmitter 615, of FIG. 6, respectively.

The NDL set manager 705 may monitor, control, or otherwise manage aspects of identifying a set of devices (e.g., STAs) associated with a wireless data link for the STA 115-r. The identified set of devices may be associated with a NAN data link and may form a subset of devices of the NDL. The identified set of devices may be time synchronized according to a beaconing operation of the NDL.

The presence indication manager 710 may monitor, control, or otherwise manage aspects of presence indication of STAs associated with a wireless data link for the STA 115-r. The presence indication manager 710 may transmit a message to the set of devices that includes a presence request indicator. Transmitting the message may include transmitting a paging message that includes a traffic indicator that conveys the presence request indicator. The traffic indicator may include a first set of fields or bits. In some examples, the fields or the bits may be information elements, where each information element of the first set of information elements may be associated with each device of the set of devices having traffic to be communicated. The traffic indicator may include a traffic indicator map, a bloom filter representing the set of devices, an ATIM, or a list of MAC addresses representing the set of devices.

The message may be transmitted during a paging window associated with the wireless data link. The paging window may be a time associated with the wireless data link where the set of devices are in an active state. More than one message including the presence request indicator may be sent to the set of devices during the paging window. The message(s) may be sent according to a predefined time schedule. In some embodiments, the paging window may be a portion of a time-block that may occur between consecutive NAN discovery windows.

The portion of the paging window when traffic advertisements are not being sent may comprise a data transmission window in which actual data is transmitted. At the beginning of the data transmission window, paged devices may send trigger frames (e.g., QoS NULL), which may act as acknowledgments to the paging message. In some examples, a transmitter may send traffic to at least one device that acknowledges the paging message.

In some aspects, the presence indication manager 710 may receive a notice of absence message from one of the devices of the set of devices. The notice of absence message may convey an indication that the at least one device is not present in the wireless data link during a portion of a schedule associated with the wireless data link. The schedule may include a repeating set of time-blocks that may occur between consecutive NAN discovery windows. The portion of the schedule may include at least one time-block. The notice of absence message may be received during a NAN discovery window associated with the NDL. The notice of absence message may include an indication that the at least one device is not present in at least one other wireless data link during the portion of the schedule.

The presence indication manager 710 may monitor a transmission from a second subset of the set of devices. The transmission may be monitored on the wireless data link. The transmission may be monitored in another wireless data link, e.g., an NDL network associated with a common synchronized wireless network cluster. The presence indication manager 710 may refrain from transmitting the message including the presence request indicator to the second subset of devices based on the monitored transmission.

The presence determination manager 715 may monitor, control, or otherwise manage aspects of determining which STAs associated with a wireless data link are present for the STA 115-r. The presence determination manager 715 may determine that a first subset of the set of devices are present in the wireless data link based on receiving a response to the message from the first subset. The response may be received during a first portion of a transmission window associated with the wireless data link. The response may include a quality of service NULL frame to convey an indication that the first subset of the set of devices are present in the wireless data link.

The presence determination manager 715 may receive the response from at least one device of the first subset of devices, the response being responsive to the at least one device receiving the message and receiving other messages from other devices of the set of devices. The presence determination manager 715 may select a contention window size associated with receiving the response from the first subset. The contention window size may be selected to prioritize transmissions of the response to the message from the first subset during a transmission window associated with the wireless data link.

The presence determination manager 715 may determine, based on receiving a notice of absence message, that at least one device of the set of devices is absent in the wireless data link. The presence determination manager 715 may determine that a second subset of the set of devices are present in the wireless data link based on the monitored transmissions.

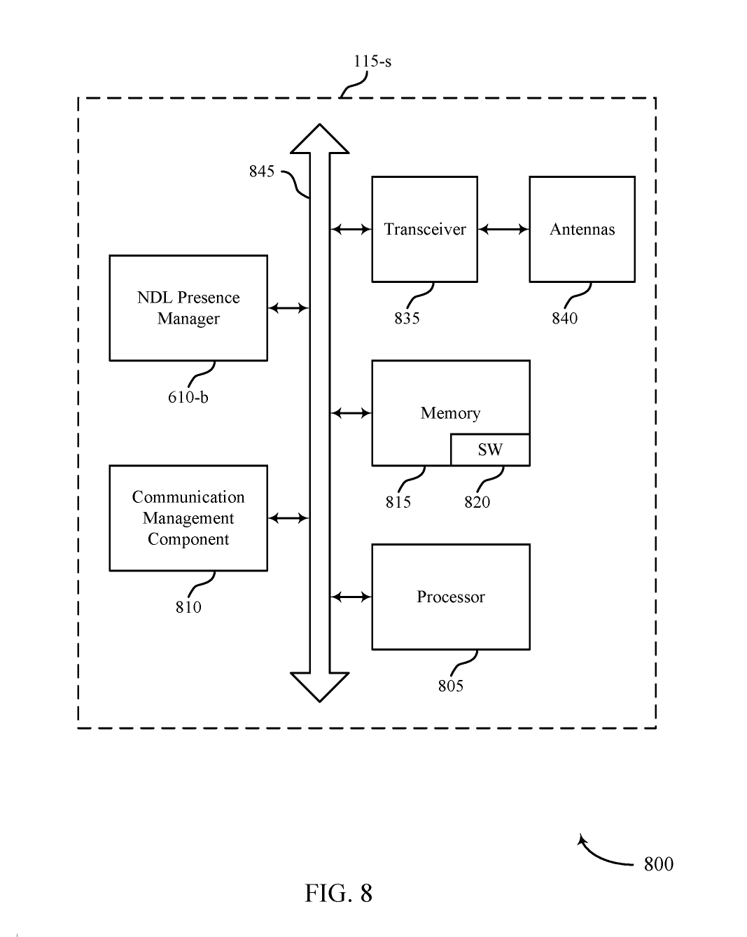

Turning to FIG. 8, a diagram 800 is shown that illustrates a STA 115-s configured for presence indication and determination in an NDL network. The STA 115-s may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The STA 115-s may have an internal power supply (not shown), such as a small battery, to facilitate mobile operation. The STA 115-s may be an example of the STAs 115 of FIGS. 1-2, 4-7.

The STA 115-s may include a processor 805, a memory 815, a transceiver 835, antennas 840, and an NDL presence manager 610-b. The NDL presence manager 610-b may be an example of, and perform the functions of the NDL presence manager 610 of FIGS. 6 and 7. Each of these components may be in communication with each other, directly or indirectly, over at least one bus 845.

The memory 815 may include random access memory (RAM) and/or read only memory (ROM). The memory 815 may store computer-readable, computer-executable software (SW) code 820 containing instructions that, when executed, cause the processor 805 to perform various functions described herein for presence indication and determination. Alternatively, the software code 820 may not be directly executable by the processor 805 but cause the computer (e.g., when compiled and executed) to perform functions described herein.

The processor 805 may include an intelligent hardware device, e.g., a CPU, a microcontroller, an ASIC, etc. The processor 805 may process information received through the transceiver 835 and/or to be sent to the transceiver 835 for transmission through the antennas 840. The processor 805 may handle, alone or in connection with the NDL presence manager 610-b, various aspects for presence indication and determination in an NDL.

The transceiver 835 may communicate bi-directionally with access points (APs). The transceiver 835 may be implemented as at least one transmitter component and at least one separate receiver component. The transceiver 835 may include a modem to modulate the packets and provide the modulated packets to the antennas 840 for transmission, and to demodulate packets received from the antennas 840. While the STA 115-s may include a single antenna, there may be aspects in which the STA 115-s may include multiple antennas 840.

According to the architecture of FIG. 8, the STA 115-s may further include a communications management component 810. The communications management component 810 may manage communications with various access points and/or other STAs, such as a set of STAs of a wireless data link. The communications management component 810 may be a component of the STA 115-s in communication with some or all of the other components of the STA 115-s over the at least one bus 845. Alternatively, functionality of the communications management component 810 may be implemented as a component of the transceiver 835, as a computer program product, and/or as at least one controller element of the processor 805.

The components of the STA 115-s may implement aspects discussed above with respect to FIGS. 1-7, and those aspects may not be repeated here for the sake of brevity. Moreover, the components of the STA 115-s may implement aspects discussed below with respect to FIGS. 9-11, and those aspects may not be repeated here also for the sake of brevity.

FIG. 9 is a flow chart illustrating an example of a method 900 for wireless communication, in accordance with various aspects of the present disclosure. For clarity, the method 900 is described below with reference to aspects of the STAs described with reference to FIGS. 1-2 and 3-8. In some examples, a STA may execute a set of codes to control the functional elements of the STA to perform the functions described below. Additionally or alternatively, the STA may perform the functions described below using special-purpose hardware.

At block 905, the method 900 may include the STA identifying a set of devices (STAs) associated with a wireless data link. At block 910, the method 900 may include the STA transmitting a message comprising a presence request indicator to the set of devices. At block 915, the method 900 may include the STA determining that a first subset of the set of devices are present in the wireless data link based on receiving a response to the message from the first subset. The operations at blocks 905, 910, and 915, may be performed using the NDL presence manager 610 described with reference to FIGS. 6-8.

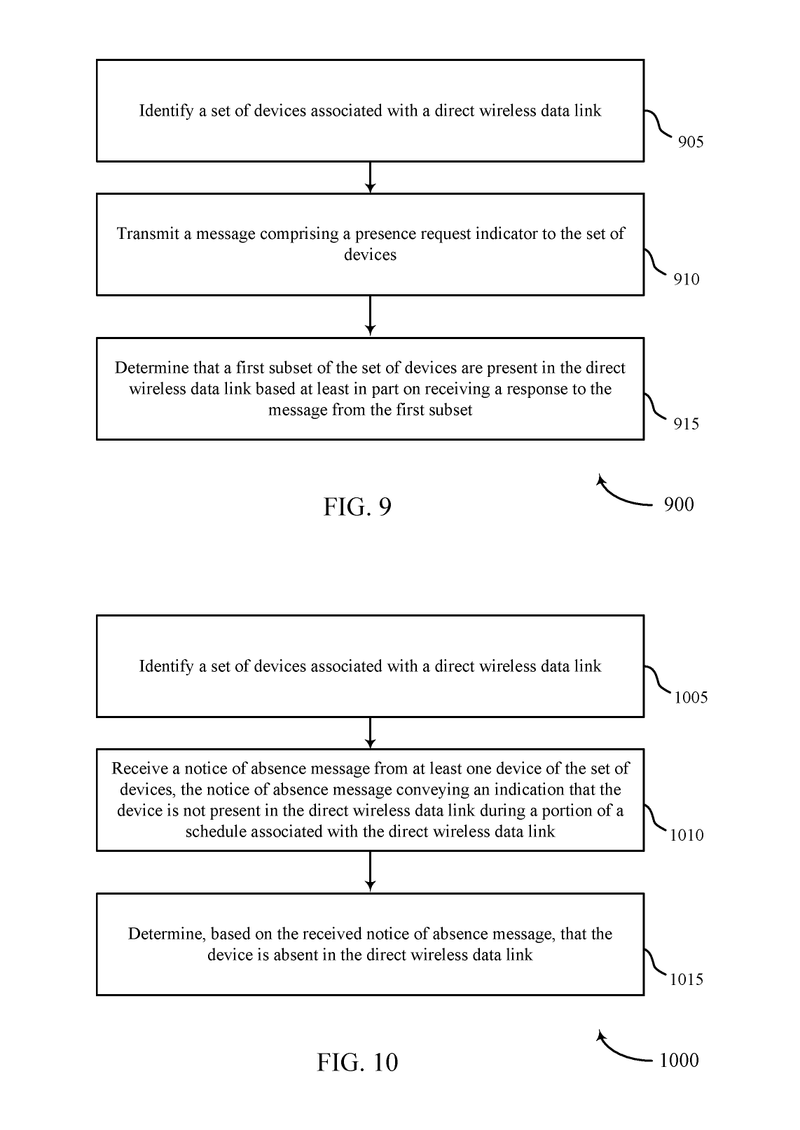

FIG. 10 is a flow chart illustrating an example of a method 1000 for wireless communication, in accordance with various aspects of the present disclosure. For clarity, the method 1000 is described below with reference to aspects of the STAs described with reference to FIGS. 1-2 and 3-8. In some examples, a STA may execute a set of codes to control the functional elements of the STA to perform the functions described below. Additionally or alternatively, the STA may perform the functions described below using special-purpose hardware.

At block 1005, the method 1000 may include the STA identifying a set of devices (STAs) associated with a wireless data link. At block 1010, the method 1000 may include the STA receiving a notice of absence message from one of the devices of the set of devices, the notice of absence message conveying an indication that the at least one device is not present in the wireless data link during a portion of a schedule associated with the wireless data link. At block 1015, the method 1000 may include the STA determining, based on the received notice of absence message, that the one of the devices is absent in the wireless data link. The operations at blocks 1005, 1010, and 1015, may be performed using the NDL presence manager 610 described with reference to FIGS. 6-8.

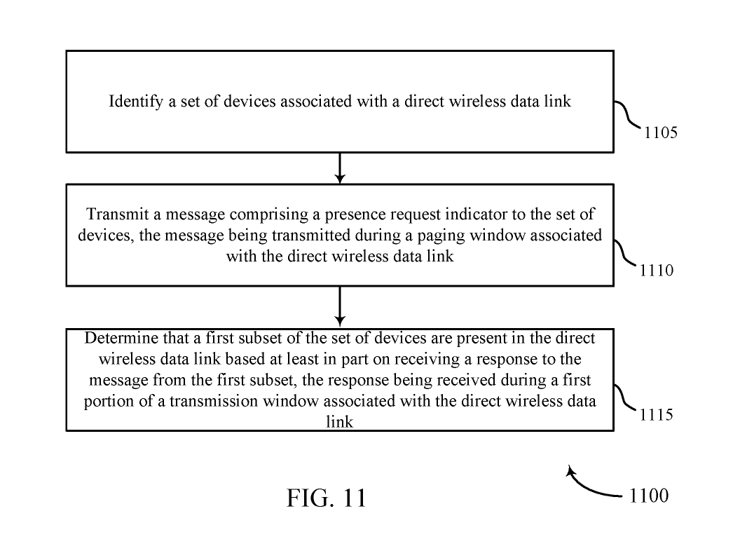

FIG. 11 is a flow chart illustrating an example of a method 1100 for wireless communication, in accordance with various aspects of the present disclosure. For clarity, the method 1100 is described below with reference to aspects of the STAs described with reference to FIGS. 1-2 and 3-8. In some examples, a STA may execute a set of codes to control the functional elements of the STA to perform the functions described below. Additionally or alternatively, the STA may perform the functions described below using special-purpose hardware.

At block 1105, the method 1100 may include the STA identifying a set of devices (STAs) associated with a wireless data link. At block 1110, the method 1100 may include the STA transmitting a message comprising a presence request indicator to the set of devices, the message being transmitted during a paging window associated with the wireless data link. At block 1115, the method 1100 may include the STA determining that a first subset of the set of devices are present in the wireless data link based on receiving a response to the message from the first subset, the response being received during a first portion of a transmission window associated with the wireless data link. The operations at blocks 1105, 1110, and 1115, may be performed using the NDL presence manager 610 described with reference to FIGS. 6-8.

Thus, the methods 900-1100 may provide for wireless communication. It should be noted that the methods 900-1100 are just one implementation and that the operations of the methods 900-1100 may be rearranged or otherwise modified such that other implementations are possible. In some examples, aspects from two or more of the methods 900-1100 may be combined.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
identifying a set of devices associated with a wireless data link;
transmitting a message comprising a presence request indicator to the set of devices; and
determining that a first subset of the set of devices are present in the wireless data link based at least in part on receiving a response to the message from the first subset.

2. The method of claim 1, wherein the wireless data link comprises a neighbor aware network (NAN) data link (NDL).

3. The method of claim 2, wherein the set of devices associated with the wireless data link are a subset of devices of a NAN cluster and are time synchronized according to a beaconing operation associated with the NAN.

4. The method of claim 2, wherein the wireless data link is associated with a schedule, the schedule comprising a repeating set of time-blocks.

5. The method of claim 4, wherein a portion of the schedule comprises at least one of the time-blocks; and
wherein the presence request indicator conveys a request of whether the set of devices are present during at least one of the time-blocks.

6. The method of claim 1, further comprising:
monitoring a transmission from a second subset of the set of devices; and
determining that the second subset of the set of devices are present based at least in part on the monitored transmission.

7. The method of claim 1, wherein determining that any device in the first subset of the set of devices is present is based at least in part on the response received to the message comprising the presence request indicator comprising a traffic announcement; and
transmitting a traffic advertisement to a second device in a second subset of the set of devices if a presence of the second device is unknown based at least in part on the traffic announcement.

8. The method of claim 6, further comprising:
refraining from transmitting a message comprising the presence request indicator to the second subset of the set of devices based at least in part on the monitored transmission.

9. The method of claim 1, wherein transmitting the message comprises:
transmitting a paging message to the set of devices, the paging message comprising an indicator, wherein at least a portion of the indicator conveys the presence request indicator.

10. The method of claim 9, wherein the indicator comprises a first set of fields, each field associated with a corresponding device of the set of devices and conveying the presence request indicator.

11. The method of claim 9, wherein the indicator further comprises a second set of fields, each field associated with a corresponding device of the set of devices having traffic to be communicated.

12. The method of claim 9, wherein the indicator comprises at least a traffic indicator map, or a bloom filter representing the set of devices, or a list of medium access control (MAC) addresses representing the set of devices, an announcement traffic indication message (ATIM) frame, or a combination thereof.

13. The method of claim 9, further comprising:
transmitting the message during a paging window associated with the wireless data link; and
receiving the response during a first portion of a transmission window associated with the wireless data link.

14. The method of claim 13, wherein the response comprises a quality-of-service (QoS) NULL frame or a NAN Management Frame (NMF) to convey an indication that any device of the first subset of the set of devices is present in the wireless data link.

15. The method of claim 13, wherein the paging window comprises a time associated with the wireless data link where the set of devices are in an active state.

16. The method of claim 1, further comprising:
selecting a contention window size associated with receiving the response from the first subset.

17. The method of claim 16, wherein the contention window size is selected to prioritize transmissions of the response to the message from the first subset during a transmission window associated with the wireless data link.

18. The method of claim 17, wherein the contention window size is selected to prioritize responses associated with a traffic announcement message, an indicator of presence, or a combination thereof.

19. The method of claim 1, further comprising:
sending more than one message to the set of devices prior to determining that at least one device of the set of devices are absent in the wireless data link, wherein the more than one message is sent according to a predefined time schedule.

20. The method of claim 1, wherein identifying the set of devices comprises identifying a security key associated with the wireless data link or a data link identifier associated with the wireless data link.

21. The method of claim 1, further comprising:
determining, based on receiving the response to the message from the first subset, that the first subset of the set of devices are present in the wireless data link during a current time-block and at least one future time-block associated with the wireless data link.

22. The method of claim 2, further comprising:
determining, based on receiving the response to the message from the first subset, that the first subset of the set of devices are present in the wireless data link; and
receiving an indication of a time value associated with a disassociation period, the time value being equal to a period of time in which at least one device associated with the first subset of the set of devices is allowed to be inactive while present in the wireless data link.

23. The method of claim 22, further comprising:
releasing resources associated with the NDL when the time value satisfies a pre-determined threshold.

24. The method of claim 22, wherein receiving the indication of the time value further comprises:
maintaining resources assigned to the NDL; and
requesting a status of a second device of the first subset of the set of devices.

25. The method of claim 24, wherein requesting the status comprises request an indication of presence, a request to release resources if the NDL is no longer active, a request to reestablish communication with the second device, or to request reassignment of the null data packet (NDP) to another device in the first subset of the set of devices.

26. The method of claim 22, wherein the time value is transmitted from at least one device associated with the first subset of the set of devices in a service discovery message.

27. The method of claim 22, wherein the time value is transmitted between devices within the first subset of the set of devices in the NDL.

28. The method of claim 22, further comprising:
receiving a packet during the period of time in which at least one device associated with the first subset of the set of devices is inactive; and
adjusting the time value based at least in part on the receiving.

29. The method of claim 1, wherein the response to the message received from the first subset comprises an indication of a time-block the first subset is present in the wireless data link.

30. A method for wireless communication, comprising:
identifying a set of devices associated with a wireless data link;
receiving a notice of absence message from at least one device of the set of devices, the notice of absence message conveying an indication that the device is not present in the wireless data link during a portion of a schedule associated with the wireless data link; and
determining, based on the received notice of absence message, that the device is absent in the wireless data link.

31. The method of claim 30, wherein the wireless data link comprises a neighbor aware network (NAN) data link (NDL).

32. The method of claim 30, further comprising:
receiving the notice of absence message during a paging window associated with the wireless data link.

33. The method of claim 30, further comprising:
receiving the notice of absence message during a NAN discovery window associated with the wireless data link, wherein the received notice of absence message indicates absence from at least one wireless data link.

34. The method of claim 33, wherein the device refrains from participating in a NDL for a pre-determined period when the notice of absence message is received during the NAN discovery window.

35. The method of claim 30, further comprising:
receiving the notice of absence message during at least one time-block associated with the NDL.

36. The method of claim 35, wherein the notice of absence message indicates absence in the NDL.

37. An apparatus for wireless communication, comprising:
an neighbor aware network (NAN) data link (NDL) set manager to identify a set of devices associated with a wireless data link;
a presence indication manager to transmit a message comprising a presence request indicator to the set of devices; and
a presence determination manager to determine that a first subset of the set of devices are present in the wireless data link based at least in part on receiving a response to the message from the first subset.

38. An apparatus for wireless communication, comprising:
a neighbor aware network (NAN) data link (NDL) set manager to identify a set of devices associated with a wireless data link;
a presence indication manager to receive a notice of absence message from at least one device of the set of devices, the notice of absence message conveying an indication that the device is not present in the wireless data link during a portion of a schedule associated with the wireless data link; and
a presence determination manager to determine, based on the received notice of absence message, that the device is absent in the wireless data link.
